(19) United States
(12) Patent Application Publication
(10) Pub. No.: US 2011/0205184 A1
(43) Pub. Date: Aug. 25, 2011

(54) ELECTRONIC INTERACTIVE DEVICE, AND RELATED MEMORY

(76) Inventors: Tin Yau Wien Tam, Kowloon (HK); Richard Ellert, New Territories (HK)

(21) Appl. No.: 13/124,858

(22) PCT Filed: Dec. 9, 2009
(86) PCT No.: PCT/IB09/55618

§ 371 Date: Apr. 19, 2011

(30) Foreign Application Priority Data
Mar. 4, 2009 (IT) TO2009A000167

(51) Int. Cl. G06F 3/044

(52) U.S. Cl. 345/174

(57) ABSTRACT

An electronic interactive device including a support base (102), a plurality of capacitive sensors (108) arranged in the support base (102), and a control circuit (30). The control circuit (30) is configured for:
a) monitoring (308) the changes of the capacitances of the capacitive sensors (108),
b) detecting (308) a position which a user is touching as a function of the changes of the capacitances of the capacitive sensors (108),
c) detecting (302) if a memory (306) contains audio data for the position, and
d) reproducing (310) the audio data if the memory (306) contains audio data for the position.

### FIELD OF THE INVENTION

The present invention relates to an electronic interactive device.

The present invention has been developed particularly for its possible use in electronic books for children having a self-reading function.

### BACKGROUND OF THE INVENTION

Electronic books with self-reading function are well known in the art. Such electronic books include at least one page on which are printed elements, such as illustrations (e.g. animals), characters (e.g. the letters of the alphabet or numbers), or words (e.g. of a story). Usually, the self-reading function is activated, when the page is opened or when a button is pressed. For example, in the case of a story, the self-reading function may reproduce the words being printed on the page.

For example, the patent U.S. Pat. No. 5,538,430 described such a book for children with self-reading function. The book comprises a sequence of elements, such as words, and under each element is disposed a visual indicator, i.e., a LED. The LEDs are automatically and sequentially illuminated when the child touches the respective switch being associated with each LED and the voice associated with the respective element is reproduced.

However, the solution described in document U.S. Pat. No. 5,538,430 has various drawbacks. Specifically, the electrical circuit is completely integrated in the book and the buttons, which activate the voice synthesizer, are disposed within each page of the book. While this solution may be convenient for a single page, is becomes rather expansive if the book comprises a plurality of pages.

### OBJECT AND SUMMARY OF THE INVENTION

The object of the invention is that of realizing an electronic interactive device which solves these disadvantages.

According to the present invention, that object is achieved by means of an electronic interactive device having the features set forth in the claims that follow. The invention also relates to a related memory.

The claims are an integral part of the disclosure of the invention provided herein.

In an embodiment, the arrangement described herein is an electronic device comprising a support base on which may be placed a book, card board, or a special plastic shape having at least one page.

In an embodiment, the support base comprises a matrix of capacitive touch sensors, which are used to determine the position a user is touching on the book.

In an embodiment, each element has associated respective audio data, which are reproduced when the user touches the element.

Specifically, in an embodiment, each page of the book has associated:
reference positions for each element, and
audio data for the respective elements and which are provided to a voice synthesizer.

In an embodiment, the book is provided together with a memory, e.g. a memory cartridge or card, on which the respective data are stored.

In an embodiment, the data associated with a specific book are memorized directly within the electronic book and each book comprises an identifier for distinguishing the books. For example, the identifier may be printed on the book and the support base may contain and optical sensor.

In an embodiment, the audio data for the voice synthesizer are stored in digital form for each element.

In an embodiment, the audio data for the voice synthesizer comprise only references to synthesized audio sequences which are stored within the electronic book.

In a preferred embodiment, each book is provided together with a memory cartridge, which comprises for the elements both the reference positions and the complete audio data. This provides the advantage that the books may be customized completely.

In an embodiment, the electronic device comprises also a page detector. For example, such a page detector may be realized by means of infrared (IR) reflection sensors, light sensors, or magnetic sensors.

In an embodiment, the electronic device comprises also a processing unit, such as a micro-processor, which evaluates the position a user is touching on the page and possibly also the current page if books which plural pages are supported.

In an embodiment, the processing unit reads the reference position data being associated with the current page from a memory and determines if the user is touching one of the elements, and if necessary activates the voice synthesizer for reproducing the audio data being associated with the respective element.

The arrangement described herein provides thus an electronic interactive device which may be used for different books.

### BRIEF DESCRIPTION OF THE DRAWINGS

The invention will now be described with reference to the attached drawings, provided by way of a non-limitative example, in which:

FIGS. 1a and 1b show exemplary embodiments of electronic devices in accordance with the invention.

FIGS. 2a and 2b show a respective paper book and card board for the electronic devices of FIGS. 1a and 1b,

FIGS. 3a and 3b show how the paper book and card board may be placed on the electronic device of FIG. 1b,

FIG. 4 is a block diagram of a control circuit for the electronic devices of FIGS. 1a and 1b, and

FIG. 5 is a scheme of a possible interface for the capacitive touch sensors of FIGS. 1a and 1b.

### DETAILED DESCRIPTION OF THE INVENTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

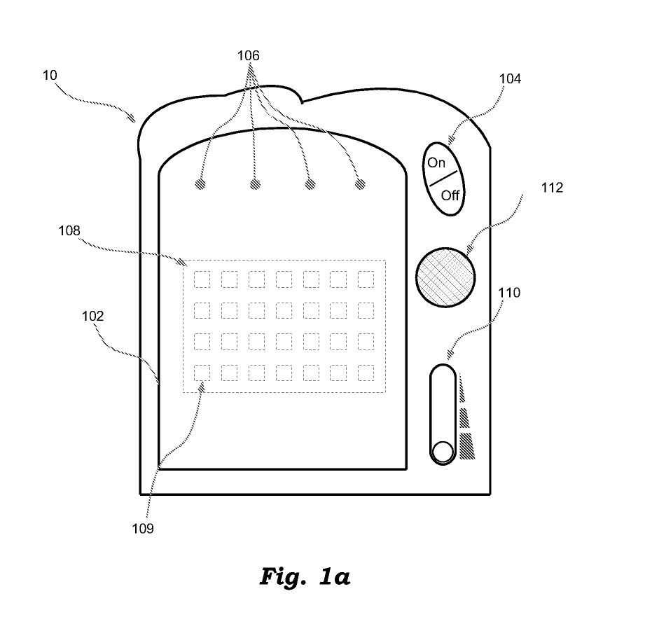

FIGS. 1a and 1b show possible embodiments of an electronic interactive device 10.

In the embodiments shown, the device 10 comprises a power switch 104, a support base 102 of substantially rectangular form, and on which may be placed a book 20 or a card board 26, for example a paper, carton o plastic book.

The electronic device may also include a cover. In this way, the power switch 104 may be realized by means of a light sensor, which activates the device when the cover is opened.

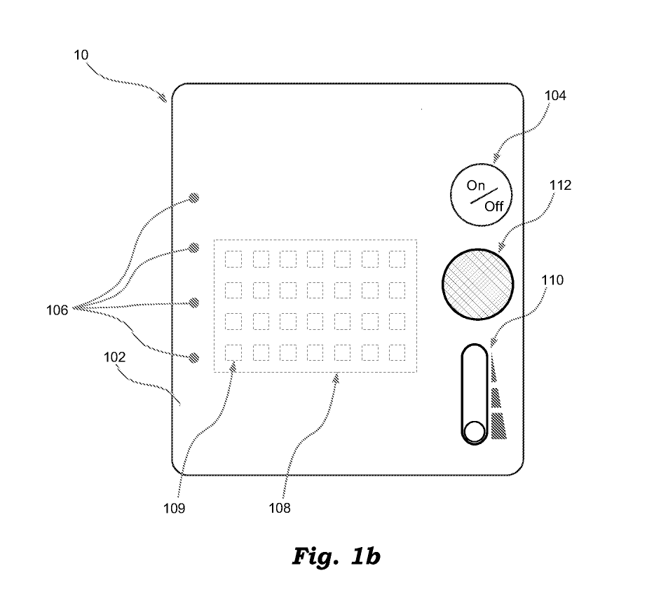

FIGS. 2a and 2b show respectively a book 20 and a card board 26, which may be placed on the support base 102. For example, the book 20 of FIG. 2a has four pages 25 and elements 24, such as printed letters, are present on each page. The card board 26 of FIG. 2b has only one page and the elements 24 may be printed geometrical forms.

In the embodiment shown in FIG. 1a, the support base 102 has a cavity being similar to the form of the book 20. The electronic device may also provide holding elements for blocking the book 20 on the support base 102.

In the embodiments considered, the electronic device 10 includes also a page sensor 106. For example, in the embodiment shown in FIG. 1a, the page sensor 106 comprises four sensors being disposed horizontally at the top portion of the support base 102. Conversely, in FIG. 1b the page sensor 106 comprises four sensors being disposed vertically at the left side of the support base 102.

The page sensor may be realized by means of optical sensors, such as four IR radiation reflection sensors or light sensors, which detect if respective portions 22a, 22b, 22c e 22d of the pages of the book 20 cover the sensors. For example, each page may contain a portion at a different position, so that up to four different pages may be detected.

The page sensor may also be realized in substantially similar way, e.g., by means of magnetic sensors, wherein respective magnets are attached at different positions to each page. The person skilled in the art will appreciate that the number of four pages has been used only as an example and that any number of pages may be supported by the electronic book.

Under or in the support base 102 are disposed a plurality of capacitive touch sensors 109. For example, FIG. 1 shows an embodiment comprising a matrix 108 of 28 touch sensors 109, which are organized in 7 rows and 4 columns.

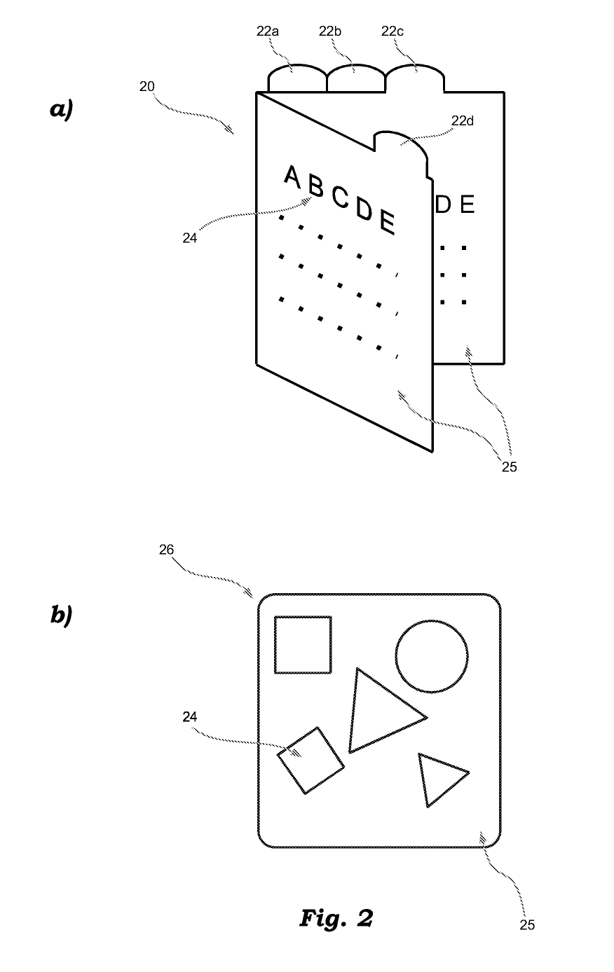

FIGS. 3a and 3b show how the book 20 or the card board 26 may be placed on the electronic interactive device of FIG. 1b. Specifically, the interactive elements 24 of the book 20 or the card board 26 should be disposed in correspondence with the capacitive sensor matrix 108. Accordingly, a user's finger F tipping or touching an element 24 of the book 20 or card board 26 will also be over the sensor matrix 108.

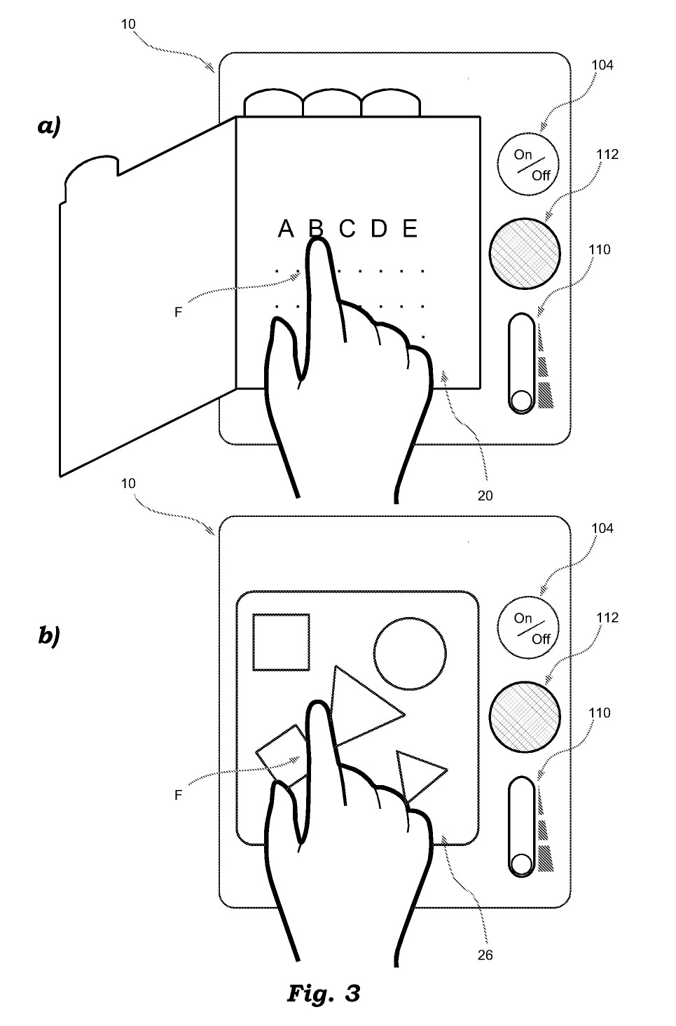

FIG. 4 shows a block diagram of a respective control circuit 30 for the electronic devices of FIGS. 1a and 1b.

The core of the control circuit 30 is a processing unit 302, e.g. a micro-processor. The processing unit 302 is fed from a power source 304, e.g. a battery or a solar panel, when the power switch 104 is in the operating position.

The control circuit includes also an interface 308 for the capacitive sensor matrix 108 and which detects the position the user is touching currently on the capacitive sensor matrix 108.

In an embodiment, the interface 308 measures the capacitance value of each capacitive sensor 109 (or at least a representative value, e.g. a charge time of the capacitive sensor) and determines a reference value for the empty sensor. Subsequently, the interface 308 monitors the changes of the capacitance values of the sensors 109 in order to detect if the user is touching the book 20 disposed on the support base 102, because e.g. his finger would add an additional capacitance.

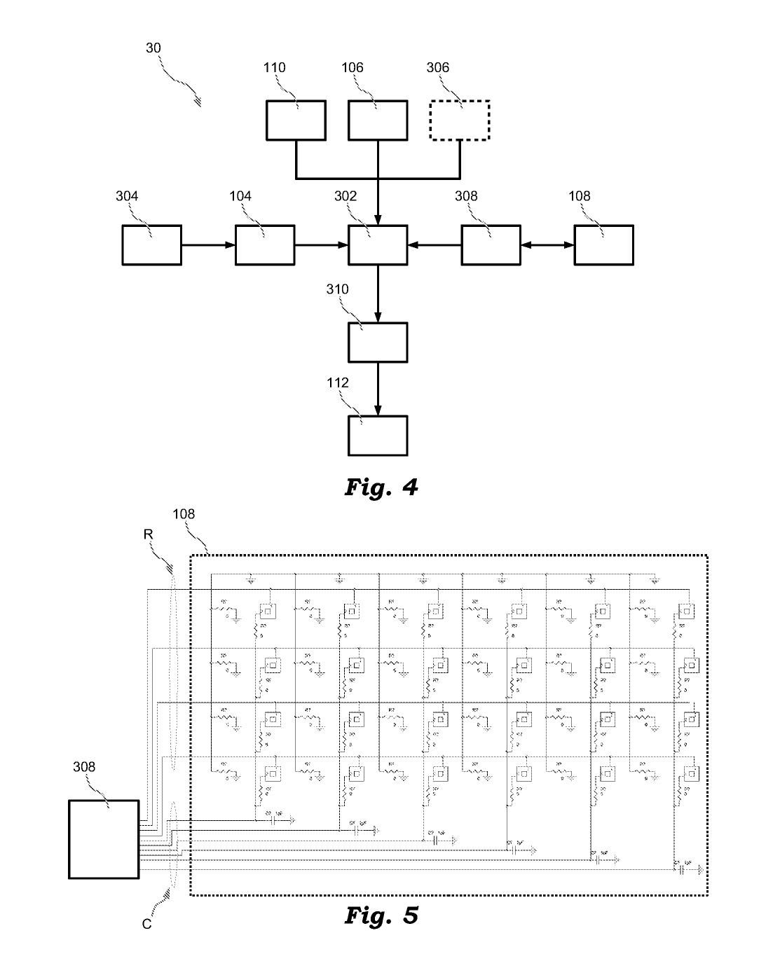

FIG. 5 shows a possible interface for the capacitive sensor matrix 108.

In this embodiment, the interface 308 is connected to the matrix by means of four lines R (one for each row) and further seven lines C (one for each column). In an embodiment, the lines R are driven sequentially and the response signals at the lines C are measured. In this way it is possible to determine which sensor is currently touched. The same scheme may also be used by driving the lines C and measuring the signals at the lines R.

In an embodiment, the interface 308 compares the capacitance values of each sensor with a predetermine threshold and determines individually for each sensor if the user is touching the respective sensor. In this case, up to 28 positions may be detected for the sensor matrix of FIGS. 1a and 1b.

In an embodiment, the interface 308 monitors the changes of all capacitive sensors for determining more accurately the position of the user's finger on the sensor matrix 108.

For example, if the finger is exactly in the middle between two sensors, both sensors exhibit the same increase in their capacitance value. In an embodiment, the interface 308 detects the changes of the capacitance values for each capacitive sensor and compares the values with the values of adjacent sensors in order to extract an “exact” position of the finger.

However, both sensors would also exhibit the same increase in their capacitance value if the user touches contemporaneously both sensors. In an embodiment, for avoiding an erroneous detection, the interface 308 compares the values with a reference threshold representing a “complete” contact. For example, this reference threshold may be determined dynamically by means of a measurement of the maximum values for the capacitance changes. Accordingly, the interface 308 may distinguish these two cases by comparing the current change with the threshold.

The processing unit 302 receives both the signals from the page detector 106 and the signal of the current position from the interface 308.

Subsequently, the processing unit 302 detects if the current page contains for the current position an element 24.

In an embodiment, the processing unit 302 compares the current page and the current position with reference positions stored in the memory 306. The processing unit may also calculate a memory address from the current page and position, and control if the respective position contains an identifier for an element 24 or directly audio data. The second solution may be advantageously, if only a limited number of positions (e.g. 28) are supported, because it is not necessary to store reference positions in the memory.

Subsequently, the processing unit 302 determines if the current element 24 has associated respective audio data (e.g. music and/or voice data) and instructs a voice synthesizer 310 for reproducing the respective audio data being stored in the memory 306.

For example, the audio data may be stored in a digital format in the memory 306 and the voice synthesizer 310 may convert these data back to analog, which are then provided to a speaker 112.

The electronic device 10 may also be used for different books. For example, this may be realized by providing the book together with the memory 306 on an external memory cartridge or card. In this way, the memory 306 contains always only the data associated with the book currently used.

In an embodiment, the memory 306 contains the data for a plurality of books and the electronic book includes an identification sensor for distinguishing the books. The person skilled in the art will appreciate that any system may be used for this scope. For example, an optical sensor may be used which recognizes a printed index on the book.

The person skilled in the art will also appreciate that the first solution is more flexible, because an unlimited number of books may be managed by the electronic book. In fact, the second solution is only feasible for a limited number of books. However, the second solution may have lower costs, because only a single memory is required, thus avoiding the use of external memories.

The solutions may also be combined for supporting a limited number of basic books with an internal memory and an unlimited number of books, which are provided with respective external memory cartridges.

The processing unit 302 and/or the voice synthesizer may also be connected to a volume control 110, e.g. a potentiometer, for regulating the volume of the reproduction.

The reproduction may also be controlled in various modes.

In an embodiment, the processing unit 302 stores the last element 24 touched in order to reproduce the respective audio data only once, in particular, when the user's finger remains on the same element 24.

In an embodiment, the processing unit 302 stores a list of positions touched by the user in order to follow the user's finger, even though audio data are already reproduced for an element 24. In this way, the user could streak the finger over an entire text line and subsequently the processing unit 302 may activate sequentially the reproduction of the audio data for the respective elements 24 of the line.

Generally, the electronic device may be used to implement any interactive function (e.g. learning or gaming functions). As mentioned in the foregoing, when a user's finger is tipping or pressing the capacitance sensor matrix, the interface 308 will monitor the capacitance changes, which allows the processing unit 302 to identify the finger's position. The processing unit 302 may thus generate an action, such as reproducing the audio data being associated with the respective position or any other possible action. Accordingly, the electronic device may react on the finger's movement, e.g. reproduce audio data with high sound quality and variable volume. In this way, the interactive device may also emulate music instruments, such as a guitar or piano.

Moreover, the structure is sufficient flexible in order to support other peripheral circuits such as phototransistors, IR sensors, magnetic switches for implementing a page detector, or a book (or game card) identification/type detector.

Naturally, various modifications to the construction details and embodiments may be possible, within the spirit of the invention according to that described and disclosed merely by way of example, without departing from the scope of the present invention, as defined by the following claims.

1. An electronic interactive device including:
a support base,
a plurality of capacitive sensors arranged in said support base, and
a control circuit configured for:
a) monitoring the changes of the capacitances of said capacitive sensors,
b) detecting a position which a user is touching as a function of said changes of the capacitances of said capacitive sensors,
c) detecting if a memory contains audio data for said position, and
d) reproducing said audio data if said memory contains audio data for said position.

2. The electronic device of claim 1, wherein said capacitive sensors are arranged as a matrix.

3. The electronic device of claim 1, including at least one page sensor for detecting the page currently opened in a book placed on said support base.

4. The electronic device of claim 3, wherein said at least one page sensor includes a plurality of sensors selected from the group consisting of infra-red reflection sensors, light sensors and/or and magnetic sensors.

5. The electronic device of claim 1, including a regulator for controlling the volume of the reproduction of said audio data.

6. The electronic device of claim 1, wherein the step of detecting if a memory contains audio data for said position includes:
loading from said memory reference positions for the elements present on the page placed on said support base, and
comparing the position which the user is touching with said reference positions.

7. The electronic device of claim 1, wherein the step of reproducing said audio data includes:
loading audio data in digital format from said memory, and
converting said audio data in analog signals.

8. The electronic device of claim 1, wherein the step of detecting a position which a user is touching as a function of said changes of the capacitances of said capacitive sensors includes comparing said changes with a threshold.

9. The electronic device of claim 1, wherein said control circuit stores the last element touched in order to reproduce the respective audio data only once if the position which the user is touching remains unchanged.

10. The electronic device of claim 1, wherein said control circuit stores a list of positions touched by the user in order to reproduce sequentially the audio data for the path of touched positions.

11. The electronic device of claim 1, wherein said capacitive sensors are operated by a human finger for reproducing the audio data being associated with the touched area.

12. The electronic device of claim 1, wherein said support base has a cavity for holding a book or card board.

13. The electronic device of claim 1, wherein said electronic device emulates a music instrument, such as a guitar or piano.

14. A memory for the electronic device of claim 1, wherein said memory is associated with at least one book or card board, and wherein said memory contains:
reference positions for at least one element present on the pages of said at least one book or card board, and
respective audio data for said at least one element.
